(19) United States
(12) Patent Application Publication
(10) Pub. No.: US 2024/0098176 A1
(43) Pub. Date: Mar. 21, 2024

(54) VOICE CALL IDENTIFICATION AND AUTHENTICATION BASED ON APPLICATION USAGE

(71) Applicant: Red Hat, Inc., Raleigh, NC (US)

(72) Inventors: Nir Magnezi, Pegah Tikva (IL); Arie Bregman, Gan Yavne (IL)

(21) Appl. No.: 17/948,824

(22) Filed: Sep. 20, 2022

(51) Int. Cl. H04M 3/22; G06F 21/32

(52) U.S. Cl. CPC H04M 3/229; G06F 21/32

(57) ABSTRACT

Systems and methods providing call identification and authentication. In one implementation, a pool of phone numbers is maintained. A request for a phone number for initiating a voice call is received from a client device. A first phone number from the pool of phone numbers is transmitted to the client device. Responsive to receiving, from the client device, the voice call at the first phone number, the client device is declared authenticated.

### TECHNICAL FIELD

The present disclosure is generally related to operating systems, and more particularly, to voice call identification and authentication based on application usage.

### BACKGROUND

A client device, such as a smartphone or tablet, can provide the user with access to multiple applications. An application can be software that is distributed through an organization, and the organization may provide support services for application users. Support services can include, for example, telephone-based customer support such as a call center. When a user calls the call center to request customer support, the user goes through an identification and/or authentication process prior to receiving the support requested.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 depicts a block diagram of an example distributed computing system operating in accordance with one or more aspects of the present disclosure.

FIG. 2 is a flow diagram of an example method for authenticating a call using a selected phone number from a pool of phone numbers, in accordance with one or more aspects of the present disclosure.

FIG. 3 is a flow diagram of an example method for authenticating a call using a short-living authentication token, in accordance with one or more aspects of the present disclosure.

FIG. 4 is a flow diagram of an example method for authenticating a call using an authentication token, in accordance with one or more aspects of the present disclosure.

FIG. 5 depicts a block diagram of an example computer system operating in accordance with one or more aspects of the present disclosure.

FIG. 6 depicts a block diagram of an illustrative computer system operating in accordance with one or more aspects of the present disclosure.

### DETAILED DESCRIPTION

Implementations of the disclosure are directed to providing voice call identification and authentication based on application usage on a client device. A client device can run a number of applications. A client device can be, for example, a mobile phone, a smart phone, a tablet, a smartwatch, etc. An application can be a network-accessible service that provides various features and functionalities to a user. Many applications require the user to create an account with the service, and the user logs into their account each time they want to use the application. The process of logging in can include, for example, providing a valid username and password combination, providing a biometric authentication, geolocation authentication, completing a two-step authentication, having the client device in proximity to a trusted secondary client device, etc. At times, the client device can store the user's login credentials, and thus the user may not need to re-authenticate themselves each time they want to use the application.

The organization providing the application may provide technical and/or customer support for users of the application. For example, a health network may provide an application, which users can use to make an appointment with a doctor. On the occasion that a user cannot find a suitable available appointment using the application, the health network may provide customer support services which the user can call to schedule an appointment. In many instances, once the user calls customer support, the user must then answer questions to re-identify and/or re-authenticate themselves to the customer support staff (i.e., a call center agent). This process of re-identification and re-authentication can include answering questions posed by the customer support staff, such as name, date of birth, social security number, and other personal identification information. The process may also include answering pre-established security-type questions, such as the user's favorite childhood pet, or the name of the street they grew up on.

Providing such information over the phone can be time consuming for the user, and can pose a security threat. For example, the user may be in a crowded environment when making the phone call, and may not want to share this information audibly, for fear that someone in the vicinity is listening. Furthermore, the identification and authentication questions posed by the customer support staff may not provide adequate security. For example, an imposter may easily obtain the answers to the security questions, and may be pose as the user when calling customer support in order to gain access to the user's private account. Thus, answering a set of questions over the phone to identify and/or authenticate a user's account may not adequately protect the user's account.

Aspects of the present disclosure address the above-noted and other deficiencies by providing secure identification and/or authentication of a client device through the user's usage of the application running on the client device (the application running on the device is hereinafter referred to as “the primary application”). The primary application can be installed on the client device, or in some embodiments, the primary application can be accessible through a network. A secure connection can be established between the client device and the server providing the primary application. For instance, a user can download the primary application onto the client device through the secure connection. The primary application can then be installed on the client device. The user can register an account with the service provider supporting the primary application. In embodiments, during the initial account setup process, the user goes through an onboarding process, which can include providing personal identification information (e.g., name, phone number, email address, etc.), creating a username and password combination, establishing two-factor authentication, biometric authentication, and/or geolocation authentication settings. The primary application can store the information associated with the account locally on the device, and/or on a server accessible via a network. During the onboarding process, the service can establish a cryptographic system to facilitate the safe exchange of messages between the client device and the server. The cryptographic system can be key cryptography, for example, in which a secret key is shared between the primary application and the call center server. Additionally or alternatively, the call center server can publish a public key, which the client device can use to encrypt communications.

Once the onboarding process is complete and the user has created an account with the primary application provider, the user can use the primary application. A user of a client device can identify and/or authenticate themselves to the primary application running on the client device using a variety of methods. For example, the user can login to their account on the primary application using a valid username and password combination, using two-factor authenticate, using biometric authentication, using geolocation authentication, or using some other valid authentication service.

While using the primary application, the user may decide to call the primary application provider for additional support (e.g., customer or technical support). The primary application may receive a request to initiate a voice call. In some embodiments, the user may indicate their desire to make a phone voice call by selecting a “make a phone call” option on the graphical user interface (GUI) of the primary application. In some embodiments, the primary application may present, to the user on a GUI, a suggestion to start a phone call responsive to a triggering event (e.g., responsive to a user search returning no results, or responsive to user inactivity for a specific period of time). When the user calls for additional support, the user may be calling a call center supported by the application provider. A call center server may receive voice calls from client devices on which the supported application is running. The call center server may authenticate the client device and/or the user of the supported application, and may direct the voice call to a call center agent. The primary application can connect to the call center server via an application programming interface (API).

Once the primary application has received a request to initiate a voice phone call (e.g., via a GUI command), the primary application transmits a notification to the server supporting the call center, indicating the request to initiate the voice call. The request can include a request for a phone number for initiating the voice call. In some embodiments, the call center server can maintain a pool of phone numbers for the call center. Then, upon receiving the request for a phone number for initiating the voice call, the call center server can select a phone number from a pool of phone numbers, and temporarily associate the selected phone number with the client device. The call center server can transmit the selected phone number to the primary application. The primary application can then cause the client device to place the voice call to the selected phone number (e.g., the primary application can transmit the selected phone number to the dialer application on the client device, and instruct the dialer application to initiate the voice call to the call center). The dialer application of the client device can be the default used by the client device to dial a phone number and initiate a voice call. Upon receiving the voice call at the selected phone number, the call center server can declare the client device authenticated. In some embodiments, as part of the authentication process, the call center server can compare the caller line identifier (i.e., the calling phone number) with a stored phone number associated with the client device (e.g., associated with the user's registered account provided during the installation/configuration process).

In some embodiments, upon receiving a request for a phone number for initiating a voice call to the data center that provides support for the primary application, the call center server can generate a one-time short-living authentication token. The short-living authentication token can be, for example, a randomly generated shortened numerical code (e.g., a 6-digit personal identification number (PIN)). The call center server can then transmit the short-living authentication token to the primary application. Alternatively, the primary application can generate the short-living authentication token and transmit it to the call center server. The short-living authentication token can be transmitted securely using, for example, a public-private key cryptography. For example, the short-living authentication token can be cryptographically signed by the client device, and/or encrypted by the public key of the call center server.

The primary application presents the short-living authentication token to the user via the client device's GUI. The primary application can then initiate a voice phone call to the call center. In some embodiments, the call center server can transmit a call center phone number to the primary application, and the primary application can cause the dialer application of the client device to initiate a voice call to the received phone number. Alternatively, the primary application can store a phone number for the call center, and the primary application can cause the dialer application of the client device to initiate a voice call to the stored phone number. When the call center receives the call, the user is asked, by the call center server, to provide the generated short-living authentication token (e.g., orally, or by entering the short-living authentication token using the keyboard). The call center server can then authenticate the client device by comparing the entered short-living authentication token with the generated short-living authentication token. The generated short-living authentication token can be any predefined number of digits, including a shortened-PIN of 6 digits. In some embodiments, as part of the authentication process, the call center server can compare the caller line identifier (i.e., the calling phone number) with a stored phone number associated with the client device (e.g., associated with the user's registered account provided during the installation/configuration process).

In some embodiments, either during the installation/configuration process and/or when a user logs into the primary application, the call center server can associate an authentication token with the client device. The authentication token can contain security credentials for a login session of the primary application, and can identify the user of the primary application as well as the primary application running on the client device. For example, the authentication token can include a signature identifying the primary application, and a payload identifying the client device and/or the user account logged into the primary application running on the client device. The call center server can generate a first authentication token using information identifying the user of the primary application (e.g., information received during the primary application installation/configuration process). In some embodiments, the call center server can associate the first authentication token with the client device upon receiving a request, from the client device, to initiate a voice call and/or a request for a phone number for initiating a voice call. The call center server can transmit a phone number to the call center to the client device.

Upon receiving the voice call from the client device, the call center server can receive a second authentication token from the client device. In some embodiments, the primary application can generate the second authentication token based on information received during installation and/or configuration of the primary application. The primary application can add the name of the application and/or a client device identifier to the second authentication token. When the primary application receives the request to initiate a voice call, the primary application can transmit the second authentication token to the dialer application, along with the phone number for the call center. The dialer application can then initiate the voice call to the call center and transmit the second authentication token to the call center server. In some embodiments, the dialer application can securely transmit the second authentication token, e.g., using the public key of the call center server. In some embodiments, the token received by the primary application during installation and/or configuration can be cryptographically signed by the client device (e.g., by the dialer application), and/or encrypted by the public key of the call center server.

The call center server receives the second authentication token and uses it to authenticate the client device. For instance, the call center server can compare the first authentication token associated with the client device to the second authentication token received from the client device. If the tokens match, the call center server can declare the client device authenticated. In some embodiments, the call center server can compare the signature of the two tokens to authenticate the client device, and then can use the payload of the second authentication token to identify the user using the client device. In some embodiments, the call center server can provide, during the installation/configuration process, an authentication token, which is stored on the client device. In some embodiments, as part of the authentication process, the call center server can compare the caller line identifier (i.e., the calling phone number) with a stored phone number associated with the client device (e.g., associated with the user's registered account provided during the installation/configuration process).

Once the call center server has authenticated the client device, using any of (or a combination of) the systems described above, the call center server can generate a notice of authentication associated with the client device. In some embodiments, the call center server declares, to the call center, that the client device has been authenticated. The call center can then display the notice of authentication to the customer support agent answering the voice call. Thus, the user of the client device can avoid answering personal questions or otherwise re-authenticating themselves upon placing the voice call to the call center.

Aspects of the present disclosure present advantages, including but not limited to, increased security and better user experience. Using one or more of the authentication methods described herein provides a higher level of security when authenticating a caller to a call center than relying on answers provided orally by the caller. The authentication is performed based on data that is unique to the usage of the application operating on the client device, and thus is less likely to succumb to malicious calling attempts. Furthermore, advantages of the present disclosure eliminate the need for a user to re-authenticate themselves when calling a call center (e.g., by answering personal questions).

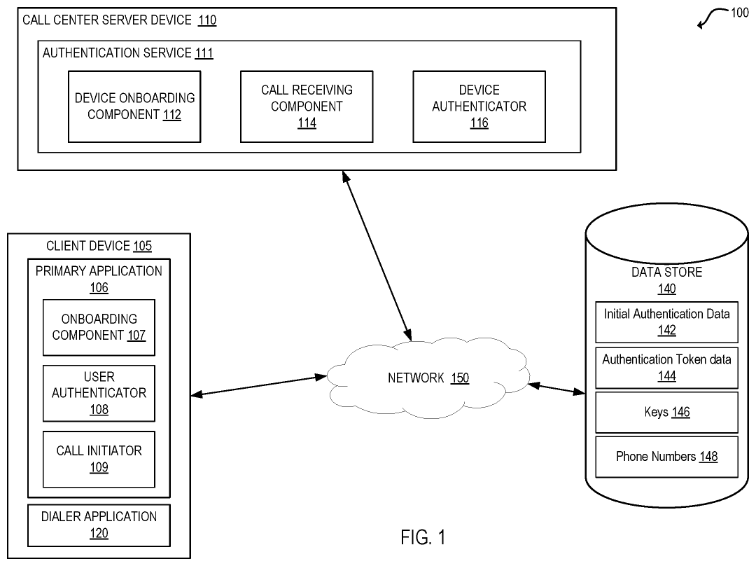

FIG. 1 is a block diagram of a distributed computing system 100, in which embodiments of the present disclosure may operate. One skilled in the art will appreciate that other architectures are possible, and that the implementation of a computer system utilizing examples of the invention are not necessarily limited to the specific architecture depicted by FIG. 1.

The distributed computing system 100 includes one or more client devices 105 connected, via a network 150, to a call center server device 110, and/or a data store 140. The call center server device 110 can receive voice calls initiated by client device 105, can authenticate the client device 105, and can forward the voice call to a call center agent. The client device 105 can include one or more processing devices communicatively coupled to memory devices and input/output devices. The client device 105 can be a laptop computer, a tablet computer, a mobile phone (e.g., a smartphone), a computing device installed in motor vehicle, in an IoT object, as a part of a mesh network, or any suitable computing device. Each computing device (e.g., the client device 105 and/or the call center server device 110) can include additional resources not pictured in FIG. 1, such as one or more central processing units (CPU), main memory, which may include volatile memory devices (e.g., random access memory (RAM)), non-volatile memory devices (e.g., flash memory) and/or other types of memory devices, a storage device (e.g., one or more magnetic hard disk drives, a Peripheral Component Interconnect (PCI) solid state drive, a Redundant Array of Independent Disks (RAID) system, a network attached storage (NAS) array, etc.), and one or more devices (e.g., a Peripheral Component Interconnect (PCI) device, network interface controller (NIC), a video card, an input/output device, etc.). In certain implementations, the main memory may be non-uniform access (NUMA), such that memory access time depends on the memory location relative to CPU.

The network 150 can be a private network (e.g., a local area network (LAN), a wide area network (WAN), intranet, etc.) or a public network (e.g., the Internet). In one example, the network 150 can include a wired or a wireless infrastructure, which can be provided by one or more wireless communications systems, such as a wireless fidelity (WiFi) hotspot connected with the network and/or a wireless carrier system that can be implemented using various data processing equipment, communication towers, etc. The client device 105 can receive data via network 150 using an application programming interface (API), for example.

In embodiments, the data store 140 can be a centrally-located database. The data store 140 can store device authentication factors, such as, initial authentication data 142, authentication token data 144, keys 146, and/or one or more pools of phone numbers 148. The initial authentication data 142 can store a username and password combination, a biometric authentication, a geolocation authentication data items associated with the client device 105, and/or user information (e.g., user name, date of birth, unique identifier associated with the client device 105 and/or user's client account, etc.). The authentication token data 144 can store security credentials associated with client device 105, which the call center server device 110 and/or the client device 105 can use to generate authentication tokens. The keys 146 can store the public key of call center server device 110 and/or the private key of client device 105, to enable a public-private key cryptography when transmitting data between the call center server device 110 and the client device 105. Each pool of phone numbers 148 can include one or more phone numbers that, when dialed, connect a user of client device 105 with the call center supported by the call center server device 110.

The client device 105 can include one or more applications 106. A primary application 106 can be a network-accessible service installed on client device 105, that provides a variety of features and functionalities to a user of client device 105. The primary application 106 can include an onboarding component 107, user authenticator service 108, and/or a call initiator service 109. The onboarding component 107 can support the installation and/or configuration of primary application 106, including providing an account registration and setup process. A user of client device 105 can sign-up for an account with the service provider supporting primary application 106. The onboarding component 107 can request personal identification information from the user, such as a name, an email address, a username and password combination, answers to personal security questions, and other similar personally identifying information. The onboarding component 107 can store the identification information locally on client device 105, and/or as part of the initial authentication data 142 in the data store 140. The onboarding component 107 can receive and transmit information to device onboarding component 112 of the call center server device 110, via network 150. In some embodiments, the onboarding component 107 can establish two-factor authentication, biometric authentication, and/or geolocation authentication settings associated with the user account. In some embodiments, the onboarding component 107 can receive an authentication token from device onboarding component 112 that the onboarding component 107 can store locally on client device 105. In some embodiments, the onboarding component 107 can receive a public key from device onboarding component 112 and transmit a private key associated with the account to device onboarding component 112, to establish a cryptographic system between the client device 105 and the call center server device 110. In some embodiments, the public key and/or private key can be stored in keys 146.

The user authenticator 108 can authenticate a user of the primary application 106. For example, the user authenticator 108 can receive a username and password combination via the primary application 106 GUI, and can authenticate the user responsive to confirming that the username and password combination is valid (e.g., match the username and password received by onboarding component 107 and/or stored in initial authentication data 142). In some embodiments, the user authenticator 108 can authenticate the user of primary application 106 using any other system established by the onboarding component 107 (e.g., the geolocation authentication, the two-factor authentication, and/or biometric authentication).

The call initiator 109 can determine to initiate a call with the call center supported by call center server device 110. In some embodiments, the call initiator 109 can receive a request to initiate a call from a user of primary application 106. For example, the user can select a “call customer support” option via the GUI of primary application 106. As another example, the call initiator 109 can suggest to the user of primary application 106 (via the GUI) that a call to customer support be initiated (e.g., responsive to determining that the user may be unable to successfully carried out their desired task).

Once the call initiator 109 has determined to initiate a call with the call center server device 110, the call initiator 109 transmits, to the authentication service 111, a notification indicating the request to call center server device 110. In some embodiments, the call initiator 109 can transmit, to the authentication service 111, a request for a phone number for initiating a voice call to the call center supported by call center server device 110.

In some embodiments, the call initiator 109 can receive a phone number for the voice call center supported by call center server device 110. The call initiator 109 can then cause the dialer application 120 on client device 105 to dial the phone number for the call center. The dialer application 120 can be used to make outgoing voice phone calls on client device 105. In some embodiments, the voice call can be placed through primary application 106 (e.g., using voice over internet protocol (VoIP)). In some embodiments, the phone number for the call center can be stored locally on client device 105, and the primary application can transmit the stored phone number to call initiator 109.

In some embodiments, in response to sending, to call center server device 110, the notification indicating the request to initiate a voice call, primary application 106 can receive a short-living authentication token from the call center server device 110. Alternatively, the primary application 106 can generate a short-living authentication and send it to the call center server device 110 (either along with the notification indicating the request to initiate the voice call, or subsequent to sending the notification indicating the request to initiate the voice call). The primary application 106 can then present the short-living authentication token to the user, e.g., via the GUI of client device 105. Once the call is initiated, the user may be asked to provide the short-living authentication token, which the user can provide either orally or via the keyboard of client device 105.

In some embodiments, primary application 106 can generate an authentication token identifying the primary application 106, the client device 105, and/or the user of primary application 106. Primary application 106 can generate the authentication token based on primary application 106 settings established during the installation and configuration process. Primary application 106 can transmit the authentication token to call center server device 110, or can transmit the authentication token to dialer application 120, which can transmit the authentication token to call center server device 110 upon initiating the voice call.

The call center server device 110 can communicate with the client device 105 via an API, or other type of specified interface having operations that server device 110 can use to transmit information (such as, initial authentication data 142, a authentication token data 144, keys 146, and/or a phone number from the phone numbers 148) to the client device 105. The authentication service 111 can facilitate the distribution of the information. The authentication service 111 can maintain the pool of phone numbers 148, including ensuring the pools of phone numbers 148 is up to date. The authentication service 111 can receive requests from a client device 105 (via network 150), and responsive to the request, can transmit information to the client device 105.

The authentication service 111 of call center server device 110 can include a device onboarding component 112, a call receiving component 114, and a device authenticator 116. The onboarding component 112 can setup user accounts for primary application 106. The onboarding component 112 can receive identifying information from a user of primary application 106, such as during an account registration procedure. In some embodiments, the onboarding component 112 can store data associated with the user, received from the primary application 106, in initial authentication data 142. This data can include, for example, the user's name, the user's date of birth, the email address associated with the account, the user's username and password, biometric authentication data, geolocation authentication data, any data that can be used by the user to login into their account associated with primary application 106, a unique identifier associated with client device 105 (e.g., the phone number of the client device 105), and other such information.

In some embodiments, the onboarding component 112 can identify a preferred authentication method associated with client device 105. The authentication method can be using a generated short-living authentication token, an authentication token, and/or using a selected phone from a pool of available phone numbers. The preferred authentication method can be determined based on settings associated with the client device 105 (e.g., the client device 105 may not support certain authentication methods), and/or based on a user's identified preferences. In some embodiments, the preferred authentication method can be identified by primary application 106, and be modified during operation of primary application 106. In some embodiments, the device onboarding component 112 can transmit, to client device 105, a first authentication factor, such as an authentication token. The authentication token can include a signature associated with primary application 106. In some embodiments, the device onboarding component 112 can transmit, to client device 105, a phone number for the call center supported by call center server device 110.

The call receiving component 114 can receive, from the primary application 106, a notification that a user of the primary application 106 running on the client device 105 has requested to initiate a voice call. The notification indicating that the user has requested to initiate a voice call can include a request for a phone number for initiating the voice to the call center. In some embodiments, in response to receiving the notification and/or the request, the call receiving component 114 can select a phone number from the pool of phone numbers 148, and can transmit the selected phone number to primary application 106 of client device 105. The call receiving component 114 can update the pool of phone numbers 148 to indicate that the selected phone number has been associated with client device 105. In some embodiments, the call receiving component 114 can associate the selected phone number in the pool of phone numbers 148 with an identifier identifying the client device 105 (e.g., the phone number of the client device 105, or a unique identifier of the client device 105), can associate the selected phone number in the pool of phone numbers 148 with an identifier identifying the user logged into primary application 106, and/or can indicate, in the pool of phone numbers 148, that the selected phone number is currently unavailable (e.g., using a binary flag). In some embodiments, the call receiving component 114 can include a timestamp of when the selected phone number was associated with client device 105. Then, when a call is received from client device 105 at the selected phone number, device authenticator 116 can authenticate client device 105. In some embodiments, device authenticator 116 can compare the caller line identifier (i.e., the calling phone number) to the stored phone number associated with client device 105 (e.g., stored in initial authentication data 142) to authenticate client device 105. In some embodiments, upon the expiration of a predetermined time period (e.g., five minutes), the call receiving component 114 can disassociate the client device 105 from the selected phone number 148, in order to free up the phone number in available phone numbers 148. In some embodiments, the device authenticator 116 can disassociate the selected phone number from the client device 105 after the call has ended.

In some embodiments, responsive to receiving the notification that a user of the primary application 106 running on the client device 105 has requested to initiate a voice call, call receiving component 114 can either receive a short-living authentication token from client device 105, or can generate a short-living authentication token and send it to client device 105. Upon receiving the voice call, the call receiving component 114 can request a short-living authentication token from client device 105. In some embodiments, primary application 106 can present the request for the short-living authentication token on the GUI of client device 105. In some embodiments, the call center employee can orally request the short-living authentication token from the user of primary application 106. Thus, the user can provide the short-living authentication token orally or by typing it into the keyboard of client device 105. The device authentication 116 can then compare the received short-living authentication token (provided by the user of primary application 106) to the original short-living authentication token. If they match, device authenticator 116 can authenticate client device 105. In some embodiments, device authenticator 116 can identify the caller line identifier (e.g., identified using a caller identification service, or a dialed number identification service) to the stored phone number associated with client device 105 (e.g., stored in initial authentication data 142) to authenticate client device 105. In some embodiments, upon the expiration of a predetermined time period, the short-living authentication token can expire, and thus the call receiving component 114 can repeat the process.

In some embodiments, the device onboarding component 112 can associate a first authentication token with the client device 105. The call receiving component 114 can receive a voice call from client device 105. In conjunction with receiving the voice call from client device 105, or in conjunction with receiving a notification indicating that a user of primary application 106 has requested to initiate a voice call, call receiving component 114 can receive a second authentication token from client device 105. In some embodiments, the second authentication token can be cryptographically signed by dialer application 120 of client device 105. In some embodiments, the second authentication token can contain the security credentials for the login session of the primary application 106, and can identify the user and the primary application 106 running on client device 105. The device authenticator 116 can compare the first and the second authentication tokens to authenticate client device 105. In some embodiments, the device authenticator 116 can validate the signature of the second authentication token to determine that the token has not been tampered with. The device authenticator 116 can then identify a payload from the token; the payload can include a client device identifier, and/or a user account identifier, for example. The device authenticator 116 can use the device identifier and/or the user account identifier to locate user data from initial authentication data 142. In some embodiments, device authenticator 116 can compare the caller line identifier (i.e., the calling phone number) to the stored phone number associated with client device 105 (e.g., stored in initial authentication data 142) to authenticate client device 105.

Upon authenticating the client device 105, the device authenticator 116 can generate a notice of authentication. The device authenticator 116 can display the notice of authentication on a GUI of call center server device 110, and/or can transmit the notice of authentication to another computing device. The notice of authentication can include information associated with client device 105, and/or with the user account signed into primary application 106 running on client device 105.

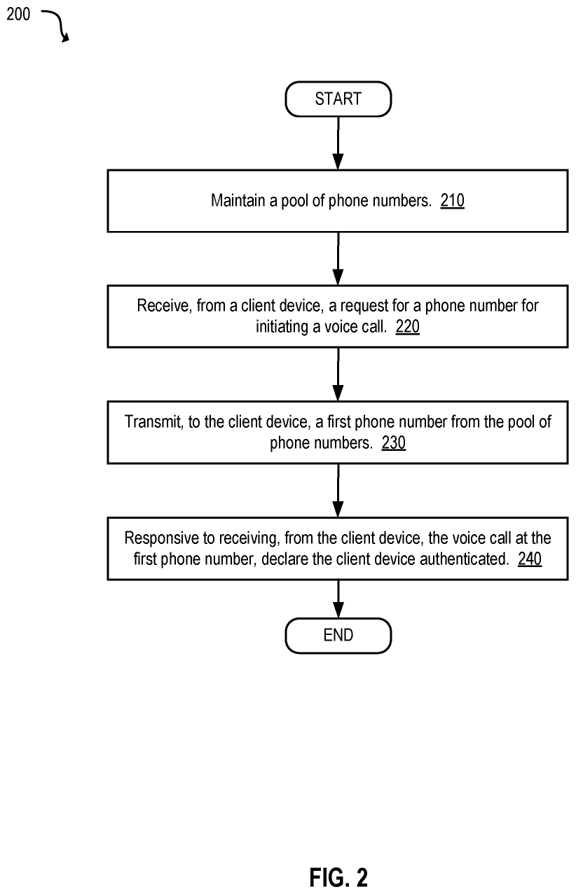

FIG. 2 depicts a flow diagram of an example method 200 for authenticating a call using a selected phone number from a pool of phone numbers, in accordance with one or more aspects of the present disclosure. Method 200 may be performed by processing logic (e.g., in call center server device 110 of FIG. 1) that may comprise hardware (e.g., circuitry, dedicated logic, programmable logic, microcode, etc.), software (such as instructions run on a processing device), firmware, or a combination thereof. Method 200 and each of its individual functions, routines, subroutines, or operations may be performed by one or more processors of the computer device executing the method. In certain implementations, method 200 may be performed by a single processing thread. Alternatively, method 200 may be performed by two or more processing threads, each thread executing one or more individual functions, routines, subroutines, or operations of the method. In an illustrative example, the processing threads implementing method 200 may be synchronized (e.g., using semaphores, critical sections, and/or other thread synchronization mechanisms). In one embodiment, method 200 may be performed by authentication service 111 of FIG. 1.

For simplicity of explanation, the methods of this disclosure are depicted and described as a series of acts. However, acts in accordance with this disclosure can occur in various orders and/or concurrently, with other acts not presented and described herein. Furthermore, not all illustrated acts may be needed to implement the methods in accordance with the disclosed subject matter. In addition, it can be appreciated that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

At block 210, processing logic maintains a pool of phone numbers. The phone numbers can, when dialed, call the customer support call center. Processing logic can maintain a data structure that lists a number of phone numbers, each phone number associated with an indicator indicating whether the phone number is available (i.e., whether the phone number is currently associated with a client device or not, e.g., using a single-bit flag indicator in which “0” indicates that the phone number is available and “1” indicates that the phone number is currently associated with a client device). In some embodiments, the indicator can include an identifier of the associated client device (e.g., the phone number of the associated client device).

At block 220, processing logic receives, from a client device (e.g., client device 105 of FIG. 1), a request for a phone number for initiating a voice call. The request can be received from primary application 106 (distinct from dialer application 120) running on client device 105. In some embodiments, the application can receive a request to initiate a voice call from a user of the client device, responsive to which the application can transmit a request for a phone number for initiating the voice call. In some embodiments, the primary application 106 can generate the request the initiate a voice call on behalf of the user of the client device, or may present, to the user (on the GUI of client device 105), a suggestion to start a voice call responsive to a triggering event (e.g., responsive to a user search returning no results, or responsive to user inactivity for a specific period of time).

In response to receiving the request for a phone number for initiating a voice call, processing logic can associate the client device phone number with the first phone number from the pool of phone numbers. The first phone number can be randomly selected from the pool of phone numbers, or can be the next available phone number in a list of available phone numbers. In some embodiments, to associate the client device phone number with the first phone number from the pool of phone numbers, the processing logic can update the pool of phone numbers data structure to reflect first phone number is currently associated with the client device.

In some embodiments, upon the expiration of a predetermined time period, the processing logic disassociates the client device phone number with the first phone number from the pool of available phone numbers. For example, the processing logic can update the pool of phone numbers data structure to reflect that the first phone number is not currently associated with the client device. The predetermined time period can be set by the application, and/or by the call center. The predetermined time period can be, for example, five minutes. In some embodiments, the processing logic can disassociate the client device phone number with the first phone number when the voice call has ended.

At block 230, processing logic transmits, to the client device a first phone number from the pool of phone numbers. At block 240, responsive to receiving, from the client device, the voice call at the first phone number, processing logic declares the client device authenticated. The voice call can be received from primary application 106 (distinct from the dialer application 120) running on client device 105. In some embodiments, the primary application 106 running on the client device 105 causes the dialer application 120 to dial the first phone number from the pool of phone numbers. The dialer application 120 can dial the phone number (i.e., can cause the device to dial the phone number), and can transmit to the processing logic, an indication that the voice call originated from the primary application 106. Thus, the processing logic can receive the voice call, along with the indication that the voice call originated from the application. The indication can be, for example, a value in a header or other portion of a notification received in conjunction with the receiving the voice call. In some embodiments, the processing logic can compare the caller line identifier (i.e., the calling phone number) with a stored phone number associated with the client device in order to declare the client device authenticated.

In embodiments, processing logic can receive, from an application running on the client device, an initial authentication credential. The initial authentication credential can be, for example, a username, a password, a biometric authentication credential, a geolocation data item, a phone number associated with the client device, and/or some other similar authentication credential. The initial authentication can identify a user account logged into the application. The processing logic can store the initial authentication credential locally, and/or in a centrally located data store. In some embodiments, the processing logic maintains a data structure in which each entry in the data structure associates the initial authentication credential(s) with an identifier identifying the client device (e.g., a unique ID associated with the client device, or the phone number of the client device). The processing logic can then authenticate the client device using the initial authentication credential.

In some embodiments, to declare the client device authenticated, the processing logic can identify a user account associated with the primary application 106 running on the client device 105. The processing logic can then generate a notice of authentication that includes one or more identifying data items associated with the user account. The identifying data items can include, for example, a name of the user associated with the user. In some embodiments, the processing logic can display the identifying data items to a call center agent receiving the voice call.

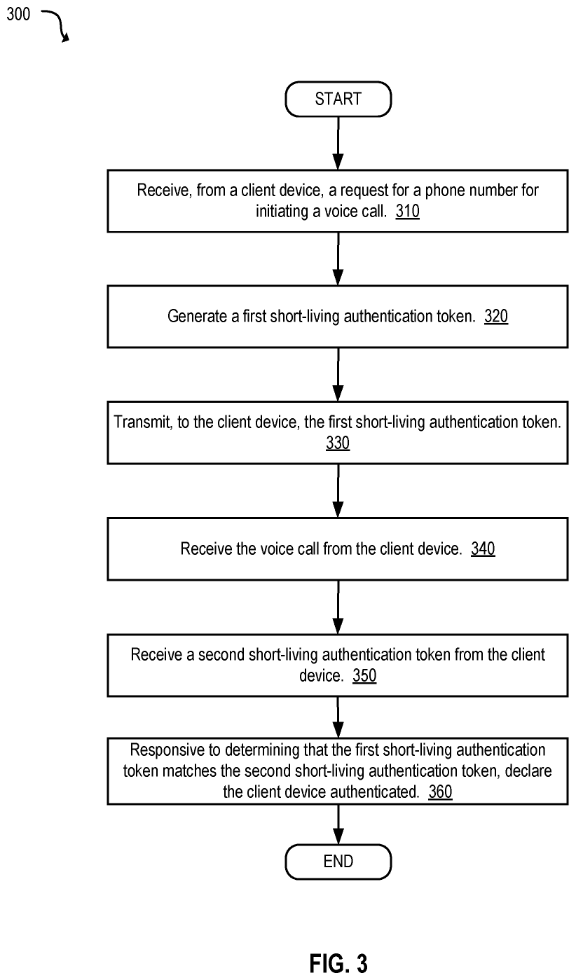

FIG. 3 depicts a flow diagram of an example method 300 for authenticating a call using a short-living authentication token, in accordance with one or more aspects of the present disclosure. Method 300 may be performed by processing logic (e.g., in call center server device 110 of FIG. 1) that may comprise hardware (e.g., circuitry, dedicated logic, programmable logic, microcode, etc.), software (such as instructions run on a processing device), firmware, or a combination thereof. Method 300 and each of its individual functions, routines, subroutines, or operations may be performed by one or more processors of the computer device executing the method. In certain implementations, method 300 may be performed by a single processing thread. Alternatively, method 300 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). In one embodiment, method 300 may be performed by authentication service 111 of FIG. 1.

For simplicity of explanation, the methods of this disclosure are depicted and described as a series of acts. However, acts in accordance with this disclosure can occur in various orders and/or concurrently, with other acts not presented and described herein. Furthermore, not all illustrated acts may be needed to implement the methods in accordance with the disclosed subject matter. In addition, it can be appreciated that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

At block 310, processing logic receives, from a client device, a request for a phone number for initiating a voice call. The processing logic can transmit, to the client device, the phone number for initiating the voice call.

At block 320, processing logic generates a first short-living authentication token. At block 330, processing logic transmits, to the client device, the first short-living authentication token. In some embodiments, processing logic transmits, to the client device, the first short-living authentication token in response to receiving, from the client device, the request for a phone number for initiating a voice call. In some embodiments, processing logic transmits, to a primary application 106 running on the client device 105, the first short-living authentication token during an onboarding process (e.g., when the primary application 106 is first installed on the client device 105), during an initialization process in which a user of the primary application 106 registers for an account with the provider of the primary application 106, during the login process (e.g., in response to receiving a valid username and password combination, or a valid biometric or geolocation authentication), and/or in response to a triggering event. The triggering event can be, for example, installing an application update, or on a determined schedule (e.g., once a week). Thus, in some embodiments, processing logic transmits the first short-living authentication token prior to receiving a request from the client device for a phone number for initiating a voice call. In some embodiments, the primary application 106 can receive the generated first short-living authentication token and display the generated first short-living authentication in a GUI of the client device 105.

At block 340, processing logic receives the voice call from the client device. At block 350, processing logic receives a second short-living authentication token from the client device. The user of the client device 105 can be asked to provide the displayed short-living authentication token once the call has been initiated. The user can provide the displayed short-living authentication token via the GUI (e.g., by typing it in on the keyboard), or can provide the displayed short-living authentication token orally.

At block 360, responsive to determining that the first short-living authentication token matches the second short-living authentication token, processing logic declares the client device authenticated. In some embodiments, the processing logic can compare the caller line identifier (i.e., the calling phone number) with a stored phone number associated with the client device in order to declare the client device authenticated. In some embodiments, in declaring the client device authenticated, the processing logic can identify a user account associated with an application running on the client device (e.g., primary application 106 running on client device 105 of FIG. 1). The processing logic can then generate a notice of authentication that includes one or more identifying data items associated with the user account. The identifying data items can include, for example, a name of the user associated with the user. In some embodiments, the processing logic can display the identifying data items to a call center agent receiving the voice call.

In embodiments, processing logic can receive, from an application running on the client device, an initial authentication credential. The initial authentication credential can be, for example, a username, a password, a biometric authentication credential, a geolocation data item, a phone number associated with the client device, and/or some other similar authentication credential. The initial authentication can identify a user account logged into the application. The processing logic can store the initial authentication credential locally, and/or in a centrally located data store. In some embodiments, the processing logic maintains a data structure in which each entry in the data structure associates the initial authentication credential(s) with an identifier identifying the client device (e.g., a unique ID associated with the client device, or the phone number of the client device). The processing logic can then authenticate the client device using the initial authentication credential.

In some embodiments, upon the expiration of a predetermined time period, processing logic can generate, and transmit to the client device, a third short-living authentication token. The processing logic can receive a fourth short-living authentication token from the client device. Responsive to determining that the third short-living authentication token matches the fourth short-living authentication token, the processing logic can declare the client device authenticated.

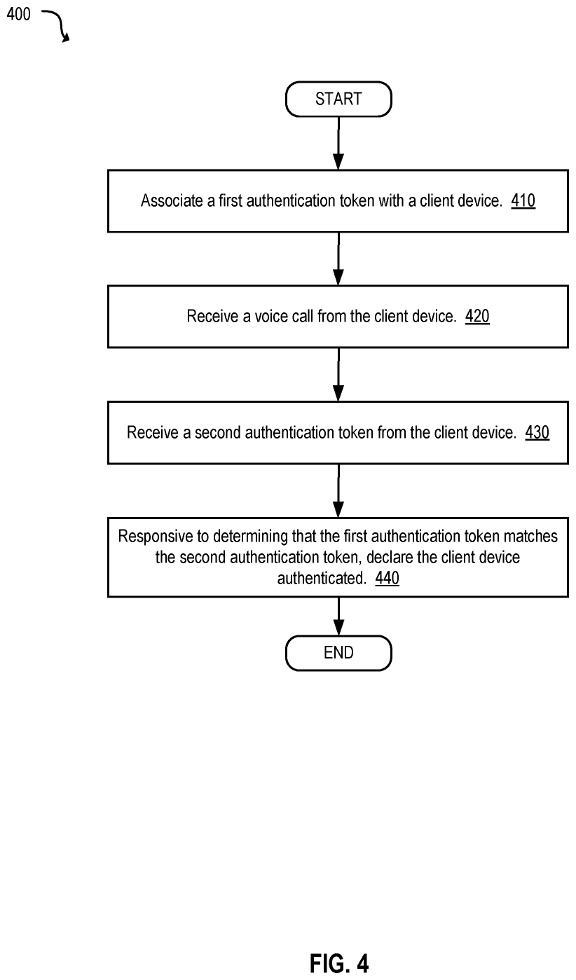

FIG. 4 depicts a flow diagram of an example method 400 for authenticating a call using an authentication token, in accordance with one or more aspects of the present disclosure. Method 400 may be performed by processing logic (e.g., in call center server device 110 of FIG. 1) that may comprise hardware (e.g., circuitry, dedicated logic, programmable logic, microcode, etc.), software (such as instructions run on a processing device), firmware, or a combination thereof. Method 400 and each of its individual functions, routines, subroutines, or operations may be performed by one or more processors of the computer device executing the method. In certain implementations, method 400 may be performed by a single processing thread. Alternatively, method 400 may be performed by two or more processing threads, each thread executing one or more individual functions, routines, subroutines, or operations of the method. In an illustrative example, the processing threads implementing method 300 may be synchronized (e.g., using semaphores, critical sections, and/or other thread synchronization mechanisms). In one embodiment, method 400 may be performed by authentication service 111 of FIG. 1.

For simplicity of explanation, the methods of this disclosure are depicted and described as a series of acts. However, acts in accordance with this disclosure can occur in various orders and/or concurrently, with other acts not presented and described herein. Furthermore, not all illustrated acts may be needed to implement the methods in accordance with the disclosed subject matter. In addition, it can be appreciated that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

At block 410, processing logic associates a first authentication token with a client device. At block 420, processing logic receives a voice call from the client device. The voice call can be received from primary application 106 (distinct from the dialer application 120) running on client device 105. In some embodiments, the primary application 106 running on the client device 105 causes the dialer application 120 to dial the first phone number from the pool of phone numbers. The dialer application 120 can dial the phone number (i.e., can cause the device to dial the phone number), and can transmit to the processing logic, an indication that the voice call originated from the primary application 106. Thus, the processing logic can receive the voice call, along with the indication that the voice call originated from the application. The indication can be, for example, a value in a header or other portion of a notification received in conjunction with the receiving the voice call.

In embodiments, processing logic can transmit the first authentication token to the client device in response to receiving, from the client device, a request for a phone number for initiating the voice call. The request can be received from primary application 106 (distinct from dialer application 120) running on client device 105. In some embodiments, the application can receive a request to initiate a voice call from a user of the client device, responsive to which the application can transmit a request for a phone number for initiating the voice call. In some embodiments, the application can generate the request the initiate a voice call on behalf of the user of the client device, or may present, to the user (on the GUI of client device 105), a suggestion to start a voice call responsive to a triggering event (e.g., responsive to a user search returning no results, or responsive to user inactivity for a specific period of time). The processing logic can transmit, to the client device, a phone number for initiating the voice call.

In some embodiments, processing logic can transmit the first authentication token to the client device in response to receiving an initial authentication credential from the client device. That is, in some embodiments, processing logic can receive, from an application running on the client device, an initial authentication credential. The initial authentication credential can be, for example, a username, a password, a biometric authentication credential, a geolocation data item, a phone number associated with the client device, and/or some other similar authentication credential. The initial authentication can identify a user account logged into the application. The processing logic can store the initial authentication credential locally, and/or in a centrally located data store. In some embodiments, the processing logic maintains a data structure in which each entry in the data structure associates the initial authentication credential(s) with an identifier identifying the client device (e.g., a unique ID associated with the client device, or the phone number of the client device). The processing logic can then authenticate the client device using the initial authentication credential.

In some embodiments, processing logic can transmit the first authentication token to the primary application 106 running on the client device during an onboarding process (e.g., when the primary application 106 is first installed on the client device 105), during an initialization process in which a user of the primary application 106 registers for an account with the provider of the primary application 106, during the login process (e.g., in response to receiving a valid username and password combination, or a valid biometric or geolocation authentication), and/or in response to a triggering event. The triggering event can be, for example, installing an application update, or on a determined schedule (e.g., once a week). Thus, in some embodiments, processing logic transmits the first authentication token prior to receiving a request from the client device for a phone number for initiating a voice call.

At block 430, processing logic receives a second authentication token from the client device. At block 440, responsive to determining that the first authentication token matches the second authentication token, processing logic declares the client device authenticated. In some embodiments, the processing logic can compare the caller line identifier (i.e., the calling phone number) with a stored phone number associated with the client device in order to declare the client device authenticated.

In some embodiments, to declare the client device authenticated, the processing logic can identify a user account associated with the application 106 running on the client device 105. The processing logic can then generate a notice of authentication that includes one or more identifying data items associated with the user account. The identifying data items can include, for example, a name of the user associated with the user. In some embodiments, the processing logic can display the identifying data items to a call center agent receiving the voice call.

The second authentication token can also include a payload identifying the client device. For example, the payload can include a first identifier associated with the client device. Responsive to determining that the first signature and the second signature match, the processing logic identifies the payload from the second token. The notice of authentication is then generated to indicate an identity of a caller associated with the first identifier. In some embodiments, for increased security, the tokens are transmitted between the client device and the processing logic using a cryptography system. That is, the authentication token can be transmitted to the client device during installation/registration of the primary application. The dialer application and/or the primary application can cryptographically sign the second authentication token, and/or encrypt the second authentication token using the public key of the server, prior to transmitting. The processing logic can then decrypt the token.

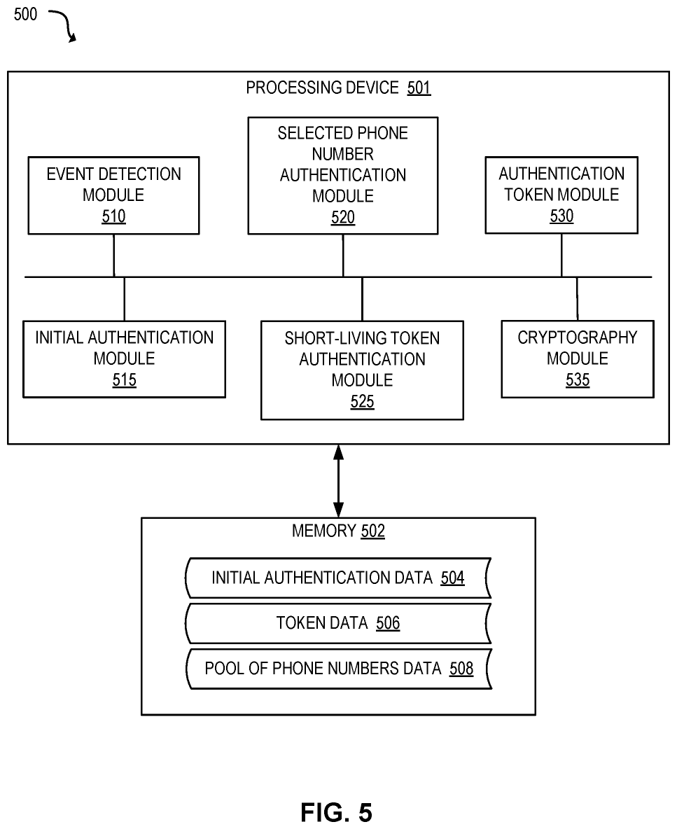

FIG. 5 depicts a block diagram of a computer system 500, operating in accordance with one or more aspects of the present disclosure. Computer system 500 may be the same or similar to call center server device 110 of FIG. 1. Computer system 500 may include an event detection module 510, an initial authentication module 515, a selected phone number authentication module 520, a short-living token authentication module 525, an authentication token module 530, and/or a cryptography module 535. Computer system 500 can also include a memory 502 that can store initial authentication data 504, token data 506, and/or pool of phone numbers data 508. Token data 506 can store data that can be used to generate a token. The data can include, for example, the token type, the cryptographic algorithm used to secure the token contents, and/or a signature associated with the application.

Pool of phone numbers data 508 can store one or more pools of available phone numbers. Each phone number in the pool of available phone numbers 508, when dialed, directs a voice call to the call center supported by processing device 501. Pool of phone numbers data 508 can be a data structure in which each entry corresponds to a phone number in the pool. Each entry can have a field indicating whether the phone number has been assigned to a client device (e.g., client device 105), and/or one or more fields indicating an allocation to a client device (e.g., a field that can store the unique identifier of the client device, such as the phone number of the client device, to which the phone number has been allocated). In some embodiments, each entry can include a timestamp indicating when the phone number was allocated to the client device.

The event detection module 510 may enable a processor to detect a variety of triggering events, such as the download and/or installation of the primary application 106 on a client device 105, initialization of a new user account registration process, an account login to the primary application 106 on a client device 105, an update to the primary application software, and/or triggering events relating to time periods (e.g., according to a determined schedule or the expiration of a time period). The triggering event can be receiving a notification from an application running on a client device (such as the primary application 106 running on client device 105 of FIG. 1). The notification can indicate a request to initiate a voice call with a call center associated with processing device 501.

The event detection module 510 may enable the processer to implement certain actions in response to the detected triggering event. In response to detecting the download, installation, and/or configuration of the primary application 106 on a client device 105, initialization of a new user account registration process (e.g., for primary application 106), an account login to the primary application 106 on a client device 105, an update to the primary application 106 software, and/or triggering events relating to time periods, the event detection module 510 may execute the initial authentication module 515, for example. In response to detecting a request to initiate a voice call, the event detection module 510 may execute the selected phone number authentication module 520, the short-living token authentication module 525, and/or the authentication token module 530. The event detection module 510 can determine which authenticator 520, 525, and/or 530 to implement based on the initial authentication data 504 associated with the client device, for example.

The initial authentication module 515 may enable a processor to receive initial authentication data from an application running on a client device (such as primary application 106 on client device 105). The initial authentication data can include, for example, a username and password authentication, a biometric authentication, a geolocation data item, and/or a phone number associated with the client device 105. The initial authentication data can be stored in initial authentication data 504 of memory 502. The initial authentication data 504 can be a data structure that associates the initial authentication data with an identifier of the user account logged into to the primary application 106 running on the client device 105, and/or with an identifier identifying the client device 105 on which the primary application 106 is running. In some embodiments, the initial authentication data 504 can include an indicator associated with each user account indicating which method of authentication (i.e., selected phone number authentication method, the short-living authentication token method, or the authentication token method). In some embodiments, the initial authentication data 504 includes an order of preference for which authentication method to use, e.g., as indicated by the primary application 106 and/or by the user of the primary application 106.

In some embodiments, the selected phone number authentication module 520 can select an available phone number from pool of phone numbers 508 and associate the selected phone number with the client device 105. The selected phone number authentication module 520 can update the pool of phone numbers 508 data structure to indicate that selected phone number is no longer available (e.g., using a binary flag), to indicate the client device 105 to which the selected phone number has been associated (e.g., using a unique identifier of the client device 105, such as the phone number of the client device 105), to indicate the user logged into the primary application 106 running on the client device 105 to which the selected phone number has been associated, and/or to indicate the time that the selected phone number was assigned to the client device 105. When a voice call is received at the selected phone number, the selected phone number authentication module 520 can authenticate the client device 105. In some embodiments, the selected phone number authentication module 520 can compare the caller line identifier (e.g., identified using a caller identification service, or a dialed number identification service) to a phone number associated with client device 105 stored in initial authentication data 504 before authenticating client device 105. Upon the expiration of a period of time, the selected phone number authentication module 520 can disassociate the selected phone number from client device 105 by updating the pool of phone numbers data 508 data structure (e.g., by removing the association or by flipping the binary flag). The selected phone number authentication module 520 can generate a notice of authentication that includes identifying data items (stored in initial authentication data 504) associated with the user account logged into primary application 106 running on client device 105.

In some embodiments, in response to receiving a request for a phone number for initiating a voice call from client device 105, the short-living token authentication module 525 can generate a short-living authentication token. The short-living token authentication module 525 can transmit, along with a phone number for initiating the voice call, the generated short-living authentication token to the client device 105 (e.g., to primary application 106). In some embodiments, rather than generating and transmitting a short-living authentication token, the short-living token authentication module 525 can receive a short-living authentication from client device 105 (e.g., from primary application 106), in conjunction with receiving the request for a phone number for initiating the voice call. The short-living authentication token can be a randomly generated numerical code, such as a 6-digit personal identification number. The short-living token authentication module 525 can transmit a phone number for initiating a voice call to primary application 106 of client device 105.

The short-living token authentication module 525 can then, upon receiving a voice call from client device 105, request that the user of primary application 106 running on client device 105 provide the short-living authentication token. The short-living token authentication module 525 can then compare the original short-living authentication token with the short-living authentication token provided by the user of primary application 106. If the two tokens match, the short-living token authentication module 525 can authenticate the client device. In some embodiments, the short-living token authentication module 525 can compare the caller line identifier (e.g., identified using a caller identification service, or a dialed number identification service) to a phone number associated with client device 105 stored in initial authentication data 504 before authenticating client device 105.

In some embodiments, the authentication token module 530 can associate a first authentication token with client device 105. The authentication token module 530 can send, to the client device 105, a phone number for imitating a voice call to the call center. Upon receiving a voice call from client device 105, the authentication token module 530 can receive a second authentication token from the client device 105. In some embodiments, the second authentication token can be received from the dialer application on the client device (e.g., dialer application 120). The authentication token module 530 can compare the first and the second authentication tokens, and if they match, the authentication token module 530 can authenticate client device 105. In some embodiments, the second authentication token can include a payload the includes a client device identifier, as well as a signature associated with the primary application. The authentication token module 530 can validate the signature to ensure that the token has not been tampered with, and can then use the payload to identify and authenticate the client device. The payload can be, for example, a unique identifier associated with the client device. The authentication token module 530 can look up the unique identifier in the initial authentication data 504 to identify the user information associated with the client device. The call authentication token module 530 can then generate a notice of authentication that includes the user information. In some embodiments, the authentication token module 530 can compare the caller line identifier (e.g., identified using a caller identification service, or a dialed number identification service) to a phone number associated with client device 105 stored in initial authentication data 504 before authenticating client device 105.

Once the client device has been authenticated, the authenticator (i.e., the selected phone number authentication module 520, the short-living token authentication module 525, and/or the authentication token module 530) can generate a notice of authentication associated with the client device 105. The authenticating module 520, 525, and/or 530 can display the notice of authentication, and/or can transmit the notice of authentication to another computing device. For example, the notice of authentication can indicate to a call center agent that the client device has been authenticated, and can provide the necessary data associated the client device (e.g., the user's name, the issue for which the user may be calling for support, etc.).

The cryptography module 535 may enable a processor to implement a cryptography system to further enhance security. In some embodiments, the cryptography module 535 can implement a public-key cryptography system. The cryptography module 535 can generate and transmit a public key to the client devices. Each client device can have a corresponding private key. The data transmitted between the processing device 501 and the client device (e.g., client device 105) can be encrypted using the selected cryptography system. The exchange of keys can occur, for example, during the initial account set-up, and/or during the initial authentication procedure.

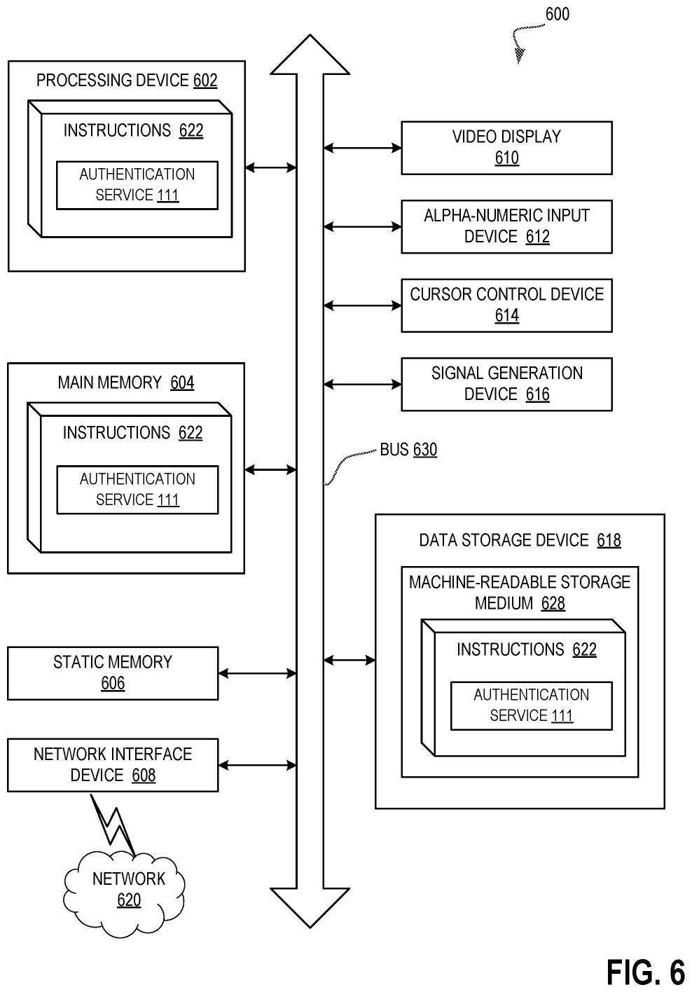

FIG. 6 is a diagrammatic representation of a machine in the exemplary form of a computer system 600 within which a set of instructions for causing the machine to perform any one or more of the methodologies discussed herein may be executed. In various illustrative examples, computer system 600 may correspond to call center server device 110 of FIG. 1 and/or computer system 500 of FIG. 5. Computer system 600 may be included within a data center that supports virtualization. Virtualization within a data center results in a physical system being virtualized using virtual machines to consolidate the data center infrastructure and increase operational efficiencies. A VM may be a program-based emulation of computer hardware resources associated with hard disks or other such memory. The VM may emulate a physical computing environment, but requests for a hard disk or memory may be managed by a virtualization layer of a host machine to translate these requests to the underlying physical computing hardware resources. This type of virtualization results in multiple VMs sharing physical resources.

In certain embodiments, computer system 600 may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. Computer system 600 may be provided by a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that device. Further, while only a single machine is illustrated, the term “computer” shall also be taken to include any collection of computers that individually or jointly execute a set (or multiple sets) of instructions to perform any one or more of the methodologies discussed herein.

The example computer system 600 may include a processing device 602, a main memory 604 (e.g., read-only memory (ROM), flash memory, dynamic random access memory (DRAM) (such as synchronous DRAM (SDRAM), etc.), a static memory 606 (e.g., flash memory, static random access memory (SRAM), etc.), and a data storage device 618, which communicate with each other via a bus 630.

Processing device 602 represents one or more general-purpose processing devices such as a microprocessor, central processing unit, or the like. More particularly, the processing device may be complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets. Processing device 602 may also be one or more special-purpose processing devices such as an application specific integrated circuit (ASIC), a field programmable gate array (FPGA), a digital signal processor (DSP), network processor, or the like. Processing device 602 may be configured to execute authentication service 111 for programming the operations and steps discussed herein.

Computer system 600 may further include a network interface device 608. Computer system 600 may also include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 616 (e.g., a speaker).

Data storage device 618 may include a machine-readable storage medium (or more specifically a computer-readable storage medium) 620 having one or more sets of instructions (e.g., authentication service 111) embodying any one or more of the methodologies of functions described herein. The authentication service 111 may also reside, completely or at least partially, within main memory 604 and/or within processing device 602 during execution thereof by computer system 600; main memory 604 and processing device 602 also constituting machine-readable storage media. Authentication service 111 may further be transmitted or received over a network 626 via network interface device 608.

Machine-readable storage medium 620 may also be used to store the device queue manner logic persistently. While machine readable storage medium 620 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instruction for execution by the machine and that causes the machine to perform any one or more of the methodologies of the present disclosure. The term “machine-readable storage medium” shall accordingly be taken to include, but not limited to, solid-state memories, and optical and magnetic media.

The components and other features described herein can be implemented as discrete hardware components or integrated in the functionality of hardware components such as ASICs, FPGAs, DSPs or similar devices. In addition, these components can be implemented as firmware or functional circuitry within hardware devices. Further, these components can be implemented in any combination of hardware devices and software components.

Some portions of the detailed descriptions are presented in terms of methods and symbolic representations of operations on data bits within a computer memory. These descriptions and representations are the means used by those skilled in the data processing arts to most effectively convey the substance of their work to others skilled in the art. A method is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “enabling,” “transmitting,” “requesting,” “identifying,” “querying,” “retrieving,” “forwarding,” “determining,” “passing,” “processing,” “issuing,” “measuring,” “caching,” “monitoring,” mapping,” “estimating,” “calculating,” “disabling,” “detecting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), erasable programmable ROMs (EPROMs), electrically erasable programmable ROMs (EEPROMs), magnetic or optical cards, flash memory devices including universal serial bus (USB) storage devices (e.g., USB key drives) or any type of media suitable for storing electronic instructions, each of which may be coupled to a computer system bus.

The methods and illustrative examples described herein are not inherently related to any particular computer or other apparatus. Various general purpose systems may be used with programs in accordance with the teachings herein or it may prove convenient to construct more specialized apparatus to perform the required method 200, and/or each of their individual functions, routines, subroutines or operations. Examples of the structure for a variety of these systems are set forth in the description above.

It is to be understood that the above description is intended to be illustrative, and not restrictive. Many other embodiments will be apparent to those of skill in the art upon reading and understanding the above description. Although the present disclosure has been described with reference to specific exemplary embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. A method comprising:
maintaining a pool of phone numbers;
receiving, from a client device, a request for a phone number for initiating a voice call;
transmitting, to the client device, a first phone number from the pool of phone numbers;
responsive to receiving, from the client device, the voice call at the first phone number, declaring the client device authenticated.

2. The method of claim 1, further comprising:
responsive to receiving the request, associating a client device phone number with the first phone number.

3. The method of claim 1, further comprising:
upon expiration of a predetermined time period, disassociating a client device phone number with the first phone number.

4. The method of claim 1, further comprising:
responsive to ending the voice call at the first phone number, disassociating a client device phone number with the first phone number.

5. The method of claim 1, further comprising:
receiving, from an application running on the client device, an initial authentication credential comprising at least one of: a username, a password, a biometric authentication credential, a geolocation data item, or a caller line identifier; and
authenticating the client device using the initial authentication credential.

6. The method of claim 1, wherein declaring the client device authenticated further comprises:
comparing a caller line identifier with a stored phone number associated with the client device.

7. The method of claim 1, wherein declaring the client device authenticated further comprises:
identifying a user account associated with an application running on the client device; and
generating a notice of authentication comprising one or more identifying data items associated with the user account.

8. A system comprising:
a memory; and
a processing device operatively coupled to the memory, the processing device to:
receive, from a client device, a request for a phone number for initiating a voice call;
generate a first short-living authentication token;
transmit, to the client device, the first short-living authentication token;
receive the voice call from the client device;
receive a second short-living authentication token from the client device; and
responsive to determining that the first short-living authentication token matches the second short-living authentication token, declare the client device authenticated.

9. The system of claim 8, wherein the processing device is further to:
receive, from the client device, an initial authentication credential comprising at least one of: a username, a password, a biometric authentication credential, a geolocation data item, or a caller line identifier; and
authenticate the client device using the initial authentication credential.

10. The system of claim 8, wherein declaring the client device authenticated, the processing device is further to:
compare a caller line identifier with a stored phone number associated with the client device.

11. The system of claim 8, wherein the processing device is further to:
upon expiration of a predetermined time period, generate a third short-living authentication token;
transmit, to the client device, the third short-living authentication token;
receive, from the client device, a fourth short-living authentication token;
responsive to determining that the third short-living authentication token matches the fourth short-living authentication token, declaring the client device authenticated.

12. The system of claim 8, wherein declaring the client device authenticated, the processing device is further to:
identify a user account associated with an application running on the client device; and
generate a notice of authentication comprising one or more identifying data items associated with the user account.

13. The system of claim 8, wherein the processing device is further to:
transmit, to the client device, the phone number for initiating the voice call.

14. A non-transitory computer-readable media storing instructions that, when executed, cause a processing device to perform operations comprising:
associating a first authentication token with a client device;
receiving a voice call from the client device;
receiving a second authentication token from the client device;
responsive to determining that the first authentication token matches the second authentication token, declaring the client device authenticated.

15. The non-transitory computer-readable media of claim 14, wherein the first authentication token is associated with the client device responsive to receiving, from the client device, a request for a phone number for initiating the voice call.

16. The non-transitory computer-readable media of claim 14, further comprising:
receiving, from the client device, an initial authentication credential comprising at least one: a username, a password, a biometric authentication credential, a geolocation data time, or a phone number; and
authenticating the client device using the initial authentication credential.

17. The non-transitory computer-readable media of claim 16, further comprising:
responsive to receiving, from the client device, the initial authentication credential, generating the first authentication token.

18. The non-transitory computer-readable media of claim 14, wherein declaring the client device authenticated further comprises:
comparing a caller line identifier with a stored phone number associated with the client device.

19. The non-transitory computer-readable media of claim 14, wherein declaring the client device authenticated further comprises:
identifying a user account associated with an application running on the client device; and
generating a notice of authentication comprising one or more identifying data items associated with the user account.

20. The non-transitory computer-readable media of claim 14, further comprising:
transmitting, to the client device, a phone number for initiating the voice call.
